(19) United States
(12) Patent Application Publication
(10) Pub. No.: US 2008/0148284 A1
(43) Pub. Date: Jun. 19, 2008

(54) APPARATUS AND METHOD FOR DEVELOPING AND EXECUTING APPLICATIONS WITH DECLARATIVE OBJECTS

(75) Inventor: Samuel Latt EPSTEIN, Kihei, HI (US)

Correspondence Address: COOLEY GODWARD KRONISH LLP;ATTN: Patent Group, Suite 1100, 777 - 6th Street, NW, Washington, DC, 20001, US

(73) Assignee: MAUI MEDIA LAB LLC, Kihei, HI (US)

(21) Appl. No.: 11/611,803

(22) Filed: Dec. 15, 2006

(51) Int. Cl. G06F 3/00; G06F 9/44

(52) U.S. Cl. 719/316; 717/117

(57) ABSTRACT

A data processing method includes declaring a server semantic object that specifies an operation independent of implementation. The server semantic object is delivered to a set of clients in different hardware environments. Each hardware environment stores a client semantic object specifying processing operations that implement the operation associated with the server semantic object for the hardware environment. The server semantic object is combined with each client semantic object in each hardware environment to produce server semantic object data at each client. The server semantic object data is presented at each client in accordance with a common protocol observed by each client.

### BRIEF DESCRIPTION OF THE INVENTION

This invention relates generally to computer programming. More particularly, this invention relates to techniques for developing computer program applications through the use of declarative objects.

### BACKGROUND OF THE INVENTION

The cost of software development can be objectively measured as a ratio representing the efforts to implement an application upon a given platform divided by the costs imposed by the platform upon the implementer. These costs are represented as a functional and syntactic litany required of the implementer in order to achieve reliability and consistency of an application. Typically, there is a direct trade-off between the inherent reliability (or lack thereof) provided by a platform and the flexibility offered by a platform with regard to application implementation. It is desirable to decouple flexibility from reliability as a means of managing development costs across multiple applications, platforms and configurations.

Many different application platforms are presently used to provide computer software applications to users. Indeed, the purveyors of these functional platforms, both proprietary and open source, cite ease of use, and reduced development effort as reasons to utilize a given application platform. Almost all of these platforms provide an Application Programmer Interface (API), which requires one or more programmers to translate the functionality of the application into computer programming that typically consists of a sequence of setting up for a call using a particular API, calling the API, processing the results returned by the API, and performing some type of logical operation and or some type of conditional or unconditional branch.

An error consisting of a single bit (e.g., a one that should be a zero, or conversely, a zero that should be a one), results in what is typically observed and described as a bug or a crash. Creating these computer code sequences is a meticulous and time consuming task, often with changes in one code, cascading and causing changes in other areas, that typically require hours of regression testing, which is costly, and as a practical matter cannot be actually completed, resulting in the regular release of application programs with many “bugs.”

Declarative systems, on the other hand, sacrifice flexibility for reliability. A declarative system defines a particular domain and limits its functionality to within that particular domain. This definitive functional sub-domain is offered to the application programmer almost as a set of multiple choice options from a menu of acceptable choices. Once the sub-domain has been implemented and completely tested, an application programmer is not able to make a “bug” or a “crash” because “bugs and crashes” are simply not made available as a declarative choice to the application programmer. A good example of a declarative system is the World Wide Web, especially as represented by Hyper Text Markup Language, HTML. HTML makes it very easy for almost anyone to create a web page through simple declarative HTML markup, without worrying about “crashing the browser.” Creating a similar web page type presentation using a functional language such as C, would be a daunting task for anyone.

In view of the foregoing, it would be desirable to provide new techniques to reduce computer program development cost, while enhancing computer program flexibility, reliability, manageability and operating costs.

### SUMMARY OF THE INVENTION

The invention includes a data processing method of declaring a server semantic object that specifies an operation independent of implementation. The server semantic object is delivered to a set of clients in different hardware environments. Each hardware environment stores a client semantic object specifying processing operations that implement the operation associated with the server semantic object for the hardware environment. The server semantic object is combined with each client semantic object in each hardware environment to produce server semantic object data at each client. The server semantic object data is presented at each client in accordance with a common protocol observed by each client.

The invention also includes a computer readable storage medium with executable instructions to specify at least one server semantic object defining server semantic object attributes and relationships. The server semantic object attributes and relationships are declared without specifying processing operations that implement the server semantic object attributes and relationships. The server semantic object is delivered to a client in response to a client request.

The invention also includes a computer readable storage medium with executable instructions to retrieve at least one server semantic object defining server semantic object attributes and relationships. The server semantic object attributes and relationships are declared without specifying processing operations that implement the server semantic object attributes and relationships. A server semantic object is combined with a corresponding client semantic object that specifies processing operations that implement the server semantic object attributes and relationships to produce data.

### BRIEF DESCRIPTION OF THE FIGURES

The invention is more fully appreciated in connection with the following detailed description taken in conjunction with the accompanying drawings, in which:

FIG. 1 illustrates a network configured in accordance with an embodiment of the invention.

FIG. 2 illustrates functional components constructed in accordance with an embodiment of the invention.

Like reference numerals refer to corresponding parts throughout the several views of the drawings.

### DETAILED DESCRIPTION OF THE INVENTION

The invention uses Declarative Object Programming. Declarative Object Programming attempts to encapsulate functional blocks into program objects that may be developed and tested independently, with little or no worry of inter-object side effects. Once constructed, program objects may be asynchronously instanced and incorporated into a computer program application, through the use of simple, declarative, XML based, Program Object Declarations that define the attributes of each particular instance of a program object, and the relationships of that particular program object to other program objects. Given this, a computer software application emerges from a collection of XML based Program Object Definitions, instantiated from pre-constructed, pre-tested and pre-qualified program objects. No new computer program code is required of an application programmer, no new code needs to be developed, debugged or tested. Certainly, Program Object Declarations need to be properly constructed, however this is a much more orthogonal and easier task than creating, integrating and qualifying new computer program code from scratch.

In accordance with the invention, the role of the server is reduced to a specialized form of a standard World Wide Web Server, a Semantic Object Distributed Event Server, which is capable of recording and reporting events, thereby interactively linking together a distributed network of related semantic objects. Specifically, the server incorporates the following standard web server functionality: store and retrieve a value, extended with functions to retrieve a previous value, retrieve a value when it changes (an event,) and retrieve a projection (a possible future value.)

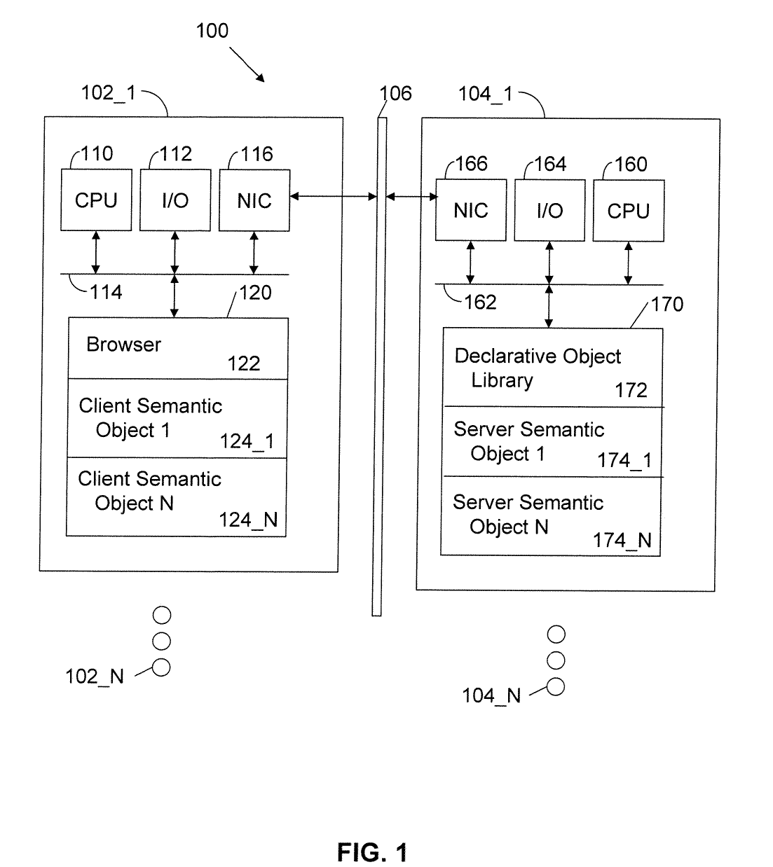

FIG. 1 illustrates a network 100 configured in accordance with an embodiment of the invention. The network 100 includes a set of client devices 102_1 through 102_N in communication with one or more servers 104_1 through 104_N via a communication link 106, which may be any wired or wireless link. A client 102 may be in the form of a personal computer, mobile phone, personal digital assistant, and the like.

In one embodiment, a client 102_1 includes a central processing unit 110 and a set of input/output devices 112 linked by a bus 114. The input/output devices 112 may include a keyboard, mouse, monitor, display, and the like. Also connected to the bus 114 is a network interface circuit 116.

A memory 120 is also connected to the bus 114. The memory 120 includes executable instructions to implement operations associated with the invention. The memory 120 may store a standard browser 122. The memory 120 may also store a set of client semantic objects 124_1 through 124_N. Each client semantic object 124 encapsulates functionality to be executed at the client 102, typically in conjunction with a browser 122. The client semantic object 124 may be optimized for the hardware associated with the client on which it is executing. Alternately, the client semantic object 124 is a more generic object corresponding to a server semantic object retrieved from a server. As discussed below, individual client semantic objects execute individually and/or in combination with other client semantic objects to implement an application

The server computer 104 includes standard components, such as a central processing unit 160 connected to a set of input/output devices 164 via a bus 162. A network interface circuit 166 is also connected to the bus 162 to facilitate network communications.

A memory 170 is also connected to the bus 162. The memory 170 includes executable programs to implement server-side operations associated with the invention. In one embodiment, the memory 170 stores a declarative object library 172. As discussed below, the declarative object library 172 specifies a set of objects that may be executed at a client 102. The memory 170 also stores a set of server semantic objects 174_1 through 174_N. The server semantic objects 174 may be downloaded and executed by clients 102. Alternately, the client may execute corresponding client semantic objects that are optimized for a given client machine.

Using browser 122, a user invokes the client hardware platform using a standard Universal Resource Locater (URL) to retrieve from a server (e.g., server 104_1) a standardized World Wide Web page. For example, the following HyperText Markup Language expression may be used: http://localhost/index.html.

This World Wide Web Page, when returned to the client 102, allows the client 102 to request the declarative object library 172 from the server 104_1. The following Code Segment A is an example of a declarative object library 172 that may be returned to a client.

```
Code Segment A
    “index.html”
    <!DOCTYPE html PUBLIC “-//W3C//DTD XHTML 1.0 Transitional//EN”
    “http://www.w3.org/tr/xhtml1/DTD/xhtml1-transitional.dtd”>
    <html>
    <head>
    <title>Maui Media Lab Application User Interface</title>
    <LINK href=“MAUIstyle.css” rel=“stylesheet” type=“text/css”>
    <script type=“text/javascript” src=“mauiobjects.js”></script>
    <script type=“text/javascript” src=“mauiobject.js”></script>
    <script type=“text/javascript” src=“mauixml.js”></script>
    <script type=“text/javascript” src=“MAUIclasses/MAUIobject/object.js”></script>
    <script type=“text/javascript” src=“MAUIclasses/MAUIbinding/object.js”></script>
    <script type=“text/javascript” src=“MAUIclasses/MAUIselector/object.js”></script>
    <script type=“text/javascript” src=“MAUIclasses/MAUIgroup/object.js”></script>
    <script type=“text/javascript” src=“MAUIclasses/MAUItable/object.js”></script>
    <script type=“text/javascript” src=“MAUIclasses/MAUIdeck/object.js”></script>
    <script type=“text/javascript” src=“MAUIclasses/MAUIprojector/object.js”></script>
    <script type=“text/javascript” src=“MAUIclasses/MAUIprogram/object.js”></script>
    <script type=“text/javascript” src=“MAUIclasses/MAUIscript/object.js”></script>
    <script type=“text/javascript” src=“MAUIclasses/MAUItransition/object.js”></script>
    <script type=“text/javascript” src=“MAUIclasses/MAUIcurve/object.js”></script>
    <script type=“text/javascript”
src=“MAUIclasses/MAUIappliance/object.js”></script>
    <script type=“text/javascript” src=“MAUIclasses/MAUIperson/object.js”></script>
    <script type=“text/javascript” src=“MAUIclasses/MAUIplace/object.js”></script>
    <script type=“text/javascript” src=“MAUIclasses/MAUIpage/object.js”></script>
    <script type=“text/javascript” src=“MAUIclasses/MAUIcontrols/object.js”></script>
    <script type=“text/javascript” src=“MAUIclasses/MAUIbutton/object.js”></script>
    <script type=“text/javascript” src=“MAUIclasses/MAUIswitch/object.js”></script>
    <script type=“text/javascript” src=“MAUIclasses/MAUIscrollbar/object.js”></script>
    <script type=“text/javascript” src=“MAUIclasses/MAUIdial/object.js”></script>
    <script type=“text/javascript” src=“MAUIclasses/MAUIfader/object.js”></script>
    <script type=“text/javascript” src=“MAUIclasses/MAUImeter/object.js”></script>
    <script type=“text/javascript” src=“MAUIclasses/MAUIfield/object.js”></script>
    <script type=“text/javascript” src=“MAUIclasses/MAUIclock/object.js”></script>
    <script type=“text/javascript” src=“MAUIclasses/MAUItext/object.js”></script>
    <script type=“text/javascript” src=“MAUIclasses/MAUIhtml/object.js”></script>
    <script type=“text/javascript” src=“MAUIclasses/MAUIimage/object.js”></script>
    <script type=“text/javascript” src=“MAUIclasses/MAUImovie/object.js”></script>
    <script type=“text/javascript” src=“MAUIclasses/MAUIsprite/object.js”></script>
    <script type=“text/javascript” src=“MAUIclasses/MAUIiframe/object.js”></script>
    </head>
    <body onload=MAUIloadDocument(“objects/object.xml”);
    onKeyDown=MAUIkeyPress(event); >
    <script>
    MAUIobjectRegisterClass( );
    MAUIbindingRegisterClass( );
    MAUIselectorRegisterClass( );
    MAUIgroupRegisterClass( );
    MAUItableRegisterClass( );
    MAUIdeckRegisterClass( );
    MAUIprojectorRegisterClass( );
    MAUIprogramRegisterClass( );
    MAUIscriptRegisterClass( );
    MAUItransitionRegisterClass( );
    MAUIcurveRegisterClass( );
    MAUIpageRegisterClass( );
    MAUIapplianceRegisterClass( );
    MAUIplaceRegisterClass( );
    MAUIpersonRegisterClass( );
    MAUIcontrolsRegisterClass( );
    MAUIbuttonRegisterClass( );
    MAUIswitchRegisterClass( );
    MAUIscrollbarRegisterClass( );
    MAUIdialRegisterClass( );
    MAUIfaderRegisterClass( );
    MAUImeterRegisterClass( );
    MAUIfieldRegisterClass( );
    MAUIclockRegisterClass( );
    MAUItextRegisterClass( );
    MAUIhtmlRegisterClass( );
    MAUIimageRegisterClass( );
    MAUImovieRegisterClass( );
    MAUIspriteRegisterClass( );
    MAUIiframeRegisterClass( );
    MAUIpaintDocument( );
    </script>
    </body>
    </html>
```

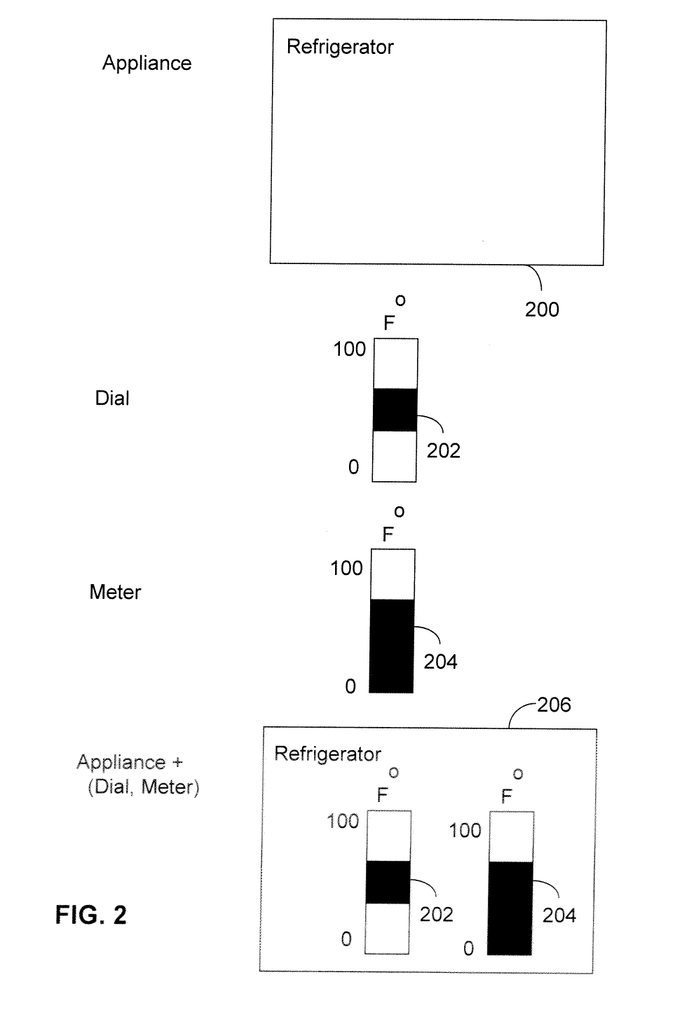

Observe that Code Segment A specifies a first declarative object, i.e., “MAUIobject/object.js”, which has a corresponding object class, i.e., MAUIobjectRegisterClass ( ). A variety of objects are declared. These objects implement functions that form an application. Observe that a number of objects implement useful features, such as an appliance (MAUIappliance/object.js), a dial (MAUIdial/object.js), and a meter (MAUImeter/object.js). The utilization of these objects to form an application is discussed below in connection with FIG. 2.

The client 102 may elect to utilize the JavaScript component object library returned from the server. Alternately, the client 102 may elect to utilize a built-in, efficiency optimized, or hardware implementation of the component object library. Alternately, the client 102 may choose to utilize some objects from the returned JavaScript component object library in combination with built-in objects, intrinsically incorporated into the client hardware platform. In one embodiment, the client 102 uses a standard URL to retrieve a standardized XML based program object declaration.

The client 102 may then construct a closure. A closure is a function that refers to free variables in a lexical context. A closure typically comes about when one function is declared entirely within the body of another, and the inner function refers to local variables of the outer function. At runtime, when the outer function executes, a closure is formed. The closure comprises the inter function's code and references to any variables in the outer function's scope that the closure needs. The following Code Segment D may be used to implement this operation.

```
APPENDIX D
    “Low Level Object and XML Support Functions”
    ////
    //
    function MAUIloadDocument(xmlfile) // MAUI Entry Point
    {
```

| | |
|---|---|
| MAUInewloadObject(xmlfile); | // load the first XML program object declaration |
| } | |
| //// | |
| // | |
| function MAUInewloadObject( | // load an XML program object declaration |

xmlfile, // XML program object declaration file identifier

| | |
|---|---|
| a, | // (optional) arguments |
| po) | // (optional) parent object reference |
| { | |

if (typeof(po)!=“undefined”)

| | |
|---|---|
| { | // if a parent object is defined |
| po.pendingobjects++; | // increment its pending object counter |
| } | |

if (typeof(a)!=“undefined” && typeof(a.path)==“undefined”)

| | |
|---|---|
| { | // if there are arguments and the path argument is undefined |

```
        a.path=“objects”;  // set it to the default “objects”
        }
    try { safeloadXMLDoc(xmlfile,safeobjectloaded, a); } // try to create closure
    catch(e) // report any errors thrown
    {
      var msg = (typeof e == “string”) ? e : ((e.message) ? e.message : “Unknown
Error”);
      alert(“Unable to get XML data:\n” + msg);
      return;
      }
    }
    ////
    //
    function safeloadXMLDoc( // create closure, load XML document, construct object
```

| | |
|---|---|
| url, | // XML program object declaration identifier |
| callback, | // callback function to call when XML file is loaded |
| a) | // (optional) arguments |

```
    {
    var safereq;
    var safeisIE = false;
      function safeprocessReqChange( ) // closure
      {
```

| | |
|---|---|
| if (safereq.readyState == 4) { | // monitor XML request process change |
| if (safereq.status == 200) { | // if readystate status is “OK” |
| callback(safereq, a); | // call the callback function |
| } | |
| else { | // otherwise if its not “OK” |

| | |
|---|---|
| --(a.parentobject.pendingobjects); | // decrease the parent object |
| | // pending objects counter |

alert(“There was a problem retrieving “+url+” XML data:\n” +

| | |
|---|---|
| safereq.statusText); | // report the error |
| } | |
| } | |
| } | |
| if (window.XMLHttpRequest) { | // if running on an open source browser |
| safereq = new XMLHttpRequest( ); | // set up the XML HTTP Request |

safereq.onreadystatechange = safeprocessReqChange; // set up the closure

| | |
|---|---|
| safereq.open(“GET”, url, true); | // open the socket |

| | |
|---|---|
| safereq.send(null); | // request the XML program object declaration file |

```
    }
      else if (window.ActiveXObject) { // otherwise if running on a Microsoft
browser
```

| | |
|---|---|
| safeisIE = true; | // note that a Microsoft browser is being used |

| | |
|---|---|
| safereq = new ActiveXObject(“Microsoft.XMLHTTP”); | // create ActiveX |
| if (safereq) { | |
| safereq.onreadystatechange = safeprocessReqChange: | // setup closure |

| | |
|---|---|
| safereq.open(“GET”, url, true); | // open the socket |

| | |
|---|---|
| safereq.send( ); | // request the XML program object declaration file |

```
      }
      }
    }
    ////
    //
```

| | |
|---|---|
| function safeobjectloaded( | // thread safe object constructor |

| | |
|---|---|
| xmlreq, | // XML request reference |
| a) | // (optional) arguments |

```
        { // setup XML program object declaration item reference
    var item = xmlreq.responseXML.getElementsByTagName(“MAUIobject”)[0];
```

| | |
|---|---|
| var i=objecti++; | // assign object id, increment global object id |
| var nid=“Layer”+i; | // setup layer identifier |
| var effectiveobject; | // setup effective object reference, and object initializer |

```
        var initializer=new MAUIinitializer(nid,i,xmlreq,“default value”, a);
        if (item.classtype==“xml”) // if the class type is generic
          {
```

| | |
|---|---|
| effectiveobject=“MAUIobject”; | // set up a generic effective object |

```
          initializer.classpath=item.classobject; // note the generic object class
          }
```

| | |
|---|---|
| else | // otherwise if the class type is NOT generic |
| { | |

| | |
|---|---|
| effectiveobject=Item.classobject; | // set up a registered effective |
| object | |
| } | |
| if (typeof(effectiveobject)!=“undefined”) | // if the effective object is defined |

| | |
|---|---|
| { | // call the constructor for the effective object with the initializer |

```
          classes.elements[effectiveobject].constructor(initializer):
          }
```

| | |
|---|---|
| else | // otherwise report the error |

```
          {
          alert(“safeobjectloaded no constructor for “+effectiveobject+” ,
”+item.classobject);
          }
        }
    ////
    //
```

| | |
|---|---|
| function postXMLDoc( | // post an XML document TO the server |

| | |
|---|---|
| url, | // XML document file identifier |
| newcontent) | // XML document file contents |
| { | |

| | |
|---|---|
| if (window.XMLHttpRequest) { | // if running on an open source browser |

```
      postreq = new XMLHttpRequest( ); // setup XML HTTP Request
      postreq.onreadystatechange = postprocessReqChange; // setup call back function
      postreq.open(“POST”, “/xmlmaui/testsavexml.php”, true); // open socket, post
      postreq.setRequestHeader(‘Content-Type’,‘application/x-www-form-
urlencoded’);
      postreq.send(“msgbody=“‘+url+”,“+newcontent+”’”);
      }
```

| | |
|---|---|
| else if (window.ActiveXObject) { | // if running on a Microsoft browser |

```
      isIE = true; // note, running on a Microsoft browser
      postreq = new ActiveXObject(“Microsoft.XMLHTTP”); // create ActiveX
      if (postreq) {
        postreq.onreadystatechange = postprocessReqChange; // setup call back func
        postreq.open(“POST”, “/xmlmaui/testsavexml.php”, true);// open socket, post
        postreq.setRequestHeader(‘Content-Type’,‘application/x-www-form-
urlencoded’);
        postreq.send(url+“,”+newcontent);
      }
      }
    }
    ////
    //
    function postprocessReqChange( ) { // monitor XML post request process change
```

| | |
|---|---|
| if (postreq.readyState == 4) { | // if ready state is “loaded” |
| // only if “OK” | |
| if (postreq.status == 200) { | // if status is “OK” |
| | // do nothing |
| } else { | // otherwise report the error |

```
        alert(“There was a problem posting the XML data:\n” +
        postreq.statusText);
      }
      }
    }
```

The client 102 may then request a standard program object declaration in the form of a standardized XML based semantic object file. In this example, an appliance object is declared. Code Segment B specifies an appliance in the form of a “refrigerator”. The appliance has a specified size (w=“900”, h=“600”) and specified characteristics (“closable”, “hidable”, “zoomable”, etc.).

```
Code Segment B.
“Program Object Declaration for an Appliance”
<?xml version=‘1.0’ encoding=‘utf-8’?>
<MAUIobject
  classobject=“MAUIappliance”
  title=“Refrigerator”
  date=“1 October, 2006”
  author=“Samuel Latt Epstein”
  w=“900”
  h=“600”
  fertile=“true”
  closable=“false”
  hidable=“false”
  zoomable=“false”
  location=“”
  node=“”
  controls=“”
  attachments=“”
  floatcontents=“false”
  >
  <item type=“all”>
  <name>Of</name>
  <id>dial</id>
  <x>30</x>
  <y>30</y>
  <path>refrigerator/dial</path>
  </item>
  <item type=“all”>
  <name>Of</name>
  <id>meter</id>
  <x>130</x>
  <y>30</y>
  <path>refrigerator/meter</path>
  <item>
</MAUIobject>
```

The following Code Segment C provides an example of code that may be used to construct the appliance object specified in Code Segment B. FIG. 2 illustrates a refrigerator appliance 200 that may be constructed in response to the execution of this code.

```
    Code Segment C.
    “Component Object Library JavaScript Implementation For an Appliance Object”
```

| | |
|---|---|
| function MAUIappliance( | // MAUI Appliance Object Entry Point |
| initializer) | // an initializer reference |

| | |
|---|---|
| { | //// prototype messages |

```
        MAUIappliance.prototype.togglecontrolsmessage=function( ) // toggle controls
            {
            MAUIobjecttogglecontrols(this);// toggle object controls with
reference
            }
```

| | |
|---|---|
| MAUIappliance.prototype.childrenloaded=function( ) | // children loaded |
| { | |
| } | |
| MAUIappliance.prototype.childloaded=function( | // child loaded |
| o) // object reference | |
| { | |
| } | |
| MAUIappliance.prototype.renderHTML=function( ) | // render HTML |
| { | |

| | |
|---|---|
| var html=this.title; | // setup HTML |
| return html; | // return HTML |
| } | |

| | |
|---|---|
| MAUIappliance.prototype.paint=function( | // paint |

| | |
|---|---|
| id, | // object identifier |
| style, | // CSS style reference |
| defaultcontent, | // default HTML content |
| index) | // object index |
| { | |

| | |
|---|---|
| var html=defaultcontent; | // setup HTML to defaultcontent |
| MAUIpaintDiv(id, html, style); | // paint DIV, with id, HTML and |
| CSS | |
| MAUIaddrendering(this,id); | // add to DOM with object ref |
| and id | |
| } | |

| | |
|---|---|
| MAUIappliance.prototype.reflectValue=function( | // reflect value |
| value) // value | |
| { | |

```
            return this.parentobject.reflectValue(value); // reflect value to parent
            }
```

| | |
|---|---|
| MAUIappliance.prototype.reflectXML=function( | // reflect XML |
| xinitializer) // initializer | |
| { | |

| | |
|---|---|
| var id=xinitializer.id; | // setup id, index and XML file |
| ref | |
| var index=xinitializer.index: | // from initializer |
| var xmlreq=xinitializer.xmlreq; | |
| if (typeof(this.path)==“undefined”) | // if path is not declared |
| { | |
| this.path=“objects”; | // set default path to “objects” |
| } | |
| var item, div, nid, x, i, j, ocontents, eparent; | |
| nid=“Layer”+index; | // setup layer id |
| this.id=nid; | // setup object id |
| // setup XML file item reference | |

item = xmlreq.responseXML.getElementsByTagName(“MAUIobject”)[0];

| | |
|---|---|
| this.classobject=item.classobject; | // reflect object class |
| this.classtype=item.classtype; | // reflect object type |
| this.description=item.description; | // reflect description |
| this.title=item.title; | // reflect title |
| this.w=item.w; | // reflect width |
| this.h=item.h; | // reflect depth |
| this.location=item.location; | // reflect location |
| this.c=item.color; | // reflect color |
| this.background=item.background; | // reflect background |
| this.backgroundrepeat=item.backgroundrepeat; | // reflect bg repeat |
| this.showcontrols=item.showcontrols; | // reflect controls flag |
| this.borderwidth=item.borderwidth; | // reflect border width |
| this.borderstyle=item.borderstyle; | // reflect border style |
| this.bordercolor=item.bordercolor; | // reflect border color |
| this.floatcontents=item.floatcontents; | // reflect float flag |

| | |
|---|---|
| eparent=this; | // setup effective parent as this object |
| i=0; | |

| | |
|---|---|
| j=2; | // loop through, reflect and construct relationships |

```
        while (item = xmlreq.responseXML.getElementsByTagName(“item”)[i])
            { // reflect relationship attributes
            ocontents = getElementTextNS(“content”, “encoded”, item, 0);
```

| | |
|---|---|
| var opath = getElementTextNS(“”, “path”, item, 0); | // path |
| var oclass = getElementTextNS(“”, “class”, item, 0); | // class |
| var oobject = getElementTextNS(“”, “object”, item, 0); | // object |
| var objx = dd.Int(getElementTextNS(“”, “x”, item, 0)); | // x |
| var objy = dd.Int(getElementTextNS(“”, “y”, item, 0)); | // y |
| var objz = 2; | // z |
| var osource=getElementTextNS(“”, “source”, item, 0); | // source |

var osourcepath=getElementTextNS(“”, “sourcepath”, item, 0);

| | |
|---|---|
| var otarget=getElementTextNS(“”, “target”, item, 0); | // target |
| var oname=getElementTextNS(“”, “name”, item, 0); | // name |
| var oicon=getElementTextNS(“”, “icon”, item, 0); | // icon |
| var oopen=getElementTextNS(“”, “open”, item, 0); | // open |

| | |
|---|---|
| if (oclass!=“n/a”) | // if object class is declared |
| { | // setup effective path |

```
                    var epath=“MAUIclasses/”+oclass+“/classes/”+oobject;
                    ocontents=epath+“/object.xml”;
                    }
                else // otherwise
                    {
```

| | |
|---|---|
| var epath; | // setup effective path |
| if (opath==“n/a”) | // if the relationship path is not |
| declared | |
| { | |

| | |
|---|---|
| epath=this.path; | // use the object path |
| } | |

| | |
|---|---|
| else | // otherwise append declared |

```
                        {
                        epath=this.path+“/”+opath; // path to object path
                        }
                    }
```

| | |
|---|---|
| var bw=0; | // setup default border width |

```
            if (typeof(this.borderwidth)!=“undefined”) // if bw declared
                {
                bw=parseInt(this.borderwidth); // then parse text to number
                }
                // instance new arguments for new relationship object
            var a=new
MAUIarguments(oname,ocontents,eparent,“contents”,objx+bw,objy+bw,objz);
```

| | |
|---|---|
| a.source=osource; | // setup relationship source object |
| a.sourcepath=osourcepath; | // set relationship source path |

a.target=this.path+“/”+opath+“/”+otarget;//setrelationship target

| | |
|---|---|
| a.targetpath=opath; | // set relationship targetpath |
| a.icon=oicon; | // set relationship icon |
| a.path=epath; | // set relationship path |
| if (this.floatcontents!=1) | // if float flag is not declared |
| { | |
| a.freeze=1; | // set freeze argument to true |
| } | |

MAUInewloadObject(“”+ocontents,a,this); // construct relative
object

| | |
|---|---|
| i++; | //index to next relationship |
| } | |
| } | |

| | |
|---|---|
| MAUIappliance.prototype.selectmessage=function( ) | // select object |
| { | |
| } | |
| MAUIappliance.prototype.closemessage=function( ) | // close message |
| { | |
| this.close( ); | |
| } | |
| MAUIappliance.prototype.close=function( ) | // close function |
| { | |

| | |
|---|---|
| MAUIobjectCloseObjects(this); | // close children objects with |
| reference | |
| MAUIunpaintDiv(this.id.this); | // unpaint DIV from DOM |

```
            this.parentobject.childclosed(this); // inform parent object, child
closed
            }
```

| | |
|---|---|
| MAUIappliance.prototype.childclosed=function( | // child closed |
| x) | |
| { | |
| } | |
| MAUIappliance.prototype.controlsloaded=function(x) | // controls loaded |
| { | |
| this.controlsobject=x; | |
| } | |
| MAUIappliance.prototype.mouseover=function( ) | // mouseover |
| { | |
| window.status=”Mouse Over Appliance”; | |
| } | |

```
    //// MAUIappliance object initializer entry point
    //
        MAUIobjectNewInitialize(this,initializer); // initialize with object ref and
initializer
        if (initializer.xmlreq) // if the initializer contains a reference to an
XML file
            {
            this.reflectXML(initializer); // reflect the XML file into the object
            }
        if (typeof(initializer.a)==“undefined” || initializer.a.reference!=1)
            {
```

| | |
|---|---|
| if (typeof(initializer.path)==“undefined”) | // if path is not declared |
| { | |
| this.path=“objects”; | // set default path |
| } | |
| else | // otherwise |
| { | |
| this.path=initializer.path; | // set declared path |
| } | |

var style=MAUIobjectStyle(this); // setup CSS style

| | |
|---|---|
| var c=“”; | // set default background color |
| if (typeof(this.c)!=“undefined”) | // if background color is declared |
| { | |
| c=“bgcolor=”+this.c; | // set HTML |
| } | |

| | |
|---|---|
| var x=“<table cellspacing=0 width=100%><tr height=22><td | “+c+” |
| width=140></td><td | “+c+” |
| align=left><b>“+this.title+”</b><br>“+this.html+”</td></tr></table>”; | |

this.paint(initializer.id, style, x); // paint object with id, CSS and HTML

| | |
|---|---|
| var bw=0; | // set default border width to 0 |
| if (typeof(this.borderwidth)!=“undefined”) | // if border width is declared |
| { | |
| bw=this.borderwidth; | // use declared border width |
| } | |
| if (this.showcontrols!=“false”) | // if showcontrols declared true |
| { | |

```
                MAUIobjectCreateControls(this,bw,bw,this.z);// create controls
                }
            MAUIobjectLink(this); // link object to its parent (successful
construct!)
          }
        }
```

| | |
|---|---|
| function MAUIapplianceRegisterClass( ) | // register Appliance object class |

| | |
|---|---|
| { | // assign Appliance Constructor to Appliance |
| Class | |

```
            MAUIregisterClass(“MAUIappliance”,MAUIapplianceConstructor);
            }
```

| | |
|---|---|
| function MAUIapplianceConstructor( | // construct Appliance object |
| initializer) // initializer | |
| { | |

var o=new MAUIappliance(initializer); // create object with initializer

| | |
|---|---|
| return o; | // return object reference |
| } | |
| ////////// | |

The following Code Segment E is a program object declaration for a dial control associated with the appliance object. The code specifies an object (i.e., MAUIobject) and a class object (i.e., MAUIdial). The title of the dial is “temperature”. The date (i.e., 1 Oct. 2006) and author (i.e., Samuel Latt Epstein) are also specified. The code also specifies characteristics associated with the dial (i.e., border, color, width and height). Thus, this code segment characterize properties of a dial.

```
Code Segment E.
“Program Object Declaration for a Dial Control”
<?xml version=‘1.0’ encoding=‘utf-8’?>
<MAUIobject
  classobject=“MAUIdial”
  title=“Of”
  date=“1 October, 2006”
  author=“Samuel Latt Epstein”
  align=“center”
  border=“1”
  bgcolor=“#4444ff”
  minimum=“0”
  maximum=“100”
  units=“degrees”
  target=“temperature”
  >
</MAUIobject>
```

The following Code Segment F is an object declaration for a meter associated with the appliance object. This code segment is similar to the code associated with the dial.

```
Code Segment F.
“Program Object Declaration for a Meter”
<?xml version=‘1.0’ encoding=‘utf-8’?>
<MAUIobject
  classobject=“MAUImeter”
  title=“Of”
  date=“1 October, 2006”
  author=“Samuel Latt Epsein”
  align=“center”
  border=“1”
  bgcolor=“#4444ff”
  minimum=“0”
  maximum=“100”
  units=“degrees”
  target=“temperature”
  >
</MAUIobject>
```

The following Code Segment G actually implements or renders the dial object declared in Code Segment E. FIG. 2 illustrates an example dial object 202 that may be constructed in response to the execution of this code.

```
    Code Segment G.
    “Component Object Library JavaScript Implementation for a Dial Object”
    //////// MAUIdial object
    // MAUIdial
    //
```

| | |
|---|---|
| function MAUIdial( | // MAUI Dial Object Entry Point |
| initializer) | // an initializer reference |
| { | //// prototype messages |

| | |
|---|---|
| MAUIdial.prototype.childrenloaded=function( ) | // children loaded |
| { | |
| } | |
| MAUIdial.prototype.childloaded=function( ) | // child loaded |
| { | |
| this.parent.thumbobject=this; | // note thumb object ref |
| } | |
| MAUIdial.prototype.childclosed=function( ) | // child closed |
| { | |
| } | |
| MAUIdial.prototype.paint=function( | // paint |
| id, | |
| style, | |
| defaultcontent, | |
| index) | |
| { | |
| var html=“<table width=100%><tr ><td | |

align=center><b>“+this.name+”</b></td></tr><tr><td
align=center><b>“+this.maximum+”</b></td></tr><tr height=70><td align=center><img
src=pixel.gif width=32 height=320></td></tr><tr height=16><td

| | |
|---|---|
| align=center><b>“+this.minimum+”</b></td></tr></table>”; | // construct HTML |
| MAUIpaintDiv(id, html, style); | |
| MAUIaddrendering(this,id); | |
| } | |

| | |
|---|---|
| MAUIdial.prototype.reflectXML=function( | // reflect XML |

| | |
|---|---|
| xinitializer) | // initializer reference |
| { | |

| | |
|---|---|
| var id=xinitializer.id; | // setup id, index and XML file |
| ref | |
| var index=xinitializer.index; | |
| var xmlreq=xinitializer.xmlreq; | |
| var target=xinitializer.a.target; | // setup target, source, paths |
| var targetpath=xinitializer.a.targetpath; | |
| var source=xinitializer.a.source; | |
| this.path=xinitializer.path; | |
| this.freeze=xinitializer.a.freeze; | |

var item = xmlreq.responseXML.getElementsByTagName(“MAUIobject”)[0];

| | |
|---|---|
| this.minimum=item.minimum; | // reflect minimum |
| this.maximum=item.maximum; | // reflect maximum |
| this.units=item.units; | // reflect units |
| this.targetfunction=item.targetfunction; | |
| this.target=target; | |
| this.targetpath=targetpath; | |
| this.source=source; | |

```
            var thumb=“MAUIclasses/MAUIdial/thumb.xml”; // create dial thumb
            var a=new
MAUIarguments(“thumbname”,thumb,this,“contents”,24,3,2);
```

| | |
|---|---|
| a.name=“ ”; | // setup initializer arguments |
| a.track=1; | // setup the thumb on a track |
| a.maxoffl=0; | // setup maximum offset to the left of the track |
| a.maxoffr=0; | // setup maximum offset to the right of the track |
| a.maxoffb=100; | // setup maximum offset from the bottom of the |
| track | |
| a.maxofft=0; | // setup maximum offset from the top of the |
| track | |
| a.path=this.path; | // propogate the path to the child object |

```
        MAUInewloadObject(thumb,a,this); // construct the thumb
            }
```

| | |
|---|---|
| MAUIdial.prototype.updateServer=function( | // update server |
| newcontent) | |
| { | |
| xmlhttppost(“temperature.xml”, newcontent); | |
| } | |
| MAUIdial.prototype.close=function( ) | // close |
| { | |
| MAUIobjectCloseContents(this); | |
| MAUIunpaintDiv(this.id,this); | |
| } | |
| MAUIdial.prototype.mouseover=function( ) | // mouseover |
| { | |
| var t=”Dial”; | |

| | |
|---|---|
| window.status=t; | // set window status line display |
| } | |

| | |
|---|---|
| MAUIdial.prototype.mouseout=function( ) | // mouseout |
| { | |
| } | |
| MAUIdial.prototype.mouseup=function( ) | // mouse up |
| { | |
| window.status=“mouseup event!”; | |
| } | |
| MAUIdial.prototype.mousedown=function( ) | // mouse down |
| { | |
| window.status=“mousedown event!”; | |
| } | |
| MAUIdial.prototype.click=function( ) | // click |
| { | |
| } | |

```
    MAUIdial.prototype.thumbmoved=function( // thumb moved (called by thumb)
        n) // new thumb value
        {
        var x=”<?xml version=‘1.0’ encoding=‘utf-8’?><MAUIobject
```

| | |
|---|---|
| classobject=‘temperature’ value=‘”+n+”’></MAUIobject>”; | // create temperature.xml |
| this.updateserver(x); // write thumb value to server | // and upload to server |
| } | |
| //// MAUIdial object initializer entry point | |
| // | |

```
    MAUIobjectNewInitialize(this,initializer); // initialize with object ref and initializer
        if (initializer.xmlreq)
            {
            this.reflectXML(initializer);
            }
```

| | |
|---|---|
| var style=MAUIobjectStyle(this); | // setup CSS |
| var nid=“Layer”+initializer.index; | // setup layer id |
| this.paint(initializer.id, style, “”, initializer.index); | // setup HTML |
| MAUIobjectLinkToParent(this, initializer.index); | // link to parent (success!) |
| } | |

| | |
|---|---|
| function MAUIdialRegisterClass( ) | // register dial object class |

```
        {
        MAUIregisterClass(“MAUIdial”,MAUIdialConstructor);
        }
```

| | |
|---|---|
| function MAUIdialConstructor( | // construct dial object |
| initializer) | // initializer reference |
| { | |
| var o=new MAUIdial(initializer); | // construct new dial object using |
| initializer | |
| return o; | // return object reference |
| } | |
| ////////// | |

The following Code Segment H is an example implementation of the previously declared meter object. This code renders the meter 204 shown in FIG. 2.

```
APPENDIX H
    “Component Object Library JavaScript Implementation for a Meter Object”
    //////// MAUImeter object
    // MAUImeter
    //
    function MAUImeter(initializer)
        {
        MAUImeter.prototype.childrenloaded=function( )
            {
            }
        MAUImeter.prototype.childloaded=function( )
            {
            }
        MAUImeter.prototype.childclosed=function( )
            {
            }
        MAUImeter.prototype.paint=function(
            id,
            style,
            defaultcontent,
            index)
            {
            var orendering;
            var html=“<table width=100%><tr ><td
align=center>“+this.name+”</td></tr><tr><td
align=center>“+this.maximum+”</td></tr><tr height=70><td align=center><img
src=pixel.gif width=32 height=”+this.metervalue*3.2+”></td></tr><tr height=16><td
```

| | |
|---|---|
| align=center>“+this.minimum+”</td></tr></table>”; | // construct HTML |

```
            MAUIpaintDiv(id, html, style);
            MAUIaddrendering(this,id);
            }
        MAUImeter.prototype.reflectXML=function(
            xinitializer)
            {
            var id=xinitializer.id;
            var index=xinitializer.index;
            var xmlreq=xinitializer.xmlreq;
            var target=xinitializer.a.target;
            var targetpath=xinitializer.a.targetpath;
            var source=xinitializer.a.source;
            var icon=xinitializer.a.icon;
            this.path=xinitializer.path;
      var item = xmlreq.responseXML.getElementsByTagName(“item”)[0];
            MAUIobjectReflectXML(this,id,index,xmlreq);
            this.minimum=getElementTextNS(“”, “minimum”, item, 0);
            this.maximum=getElementTextNS(“”, ”maximum”, item, 0);
            this.units=getElementTextNS(“”, “units”, item, 0);
            this.direction=getElementTextNS(“”, “direction”, item, 0);
        this.targetfunction=getElementTextNS(“”, “targetfunction”, item, 0);
            this.target=target;
            this.targetpath=targetpath;
            this.source=source;
        this.metervalue=0;
            }
```

| | |
|---|---|
| MAUImeter.prototype.update=function(newcontent) | // undate |

```
            {
    var item = xmlreq.responseXML.getElementsByTagName(“MAUIobject”)[0];
```

| | |
|---|---|
| this.metervalue=item.temperature; | // set meter value |
| var style=MAUIobjectStyle(this); | // setup style and layer id |
| var nid=“Layer”+initializer.index; | |

| | |
|---|---|
| MAUIunpaintDiv(this.id,this); | // unpaint previous rendering |

| | |
|---|---|
| this.paint(this.id, style,””, initializer.index); | // paint meter |
| safeloadXML(“temperature.xml”, this.update) | // update meter |
| } | |
| MAUImeter.prototype.close=function( ) | // close |
| { | |

| | |
|---|---|
| MAUIunpaintDiv(this.id,this); | // unpaint rendering |
| } | |

| | |
|---|---|
| MAUImeter.prototype.doubleclick=function( ) | // double click |
| { | |
| } | |

| | |
|---|---|
| MAUImeter.prototype.mouseover=function( ) | // mouse over |
| { | |
| var t=”Meter”; | |

```
            window.status=t; // set window status line display
            }
```

| | |
|---|---|
| MAUImeter.prototype.mouseout=function( ) | // mouse out |
| { | |
| } | |
| MAUImeter.prototype.mouseup=function( ) | // mouse up |
| { | |
| } | |
| MAUImeter.prototype.mousedown=function( ) | // mouse down |
| { | |
| window.status=“mousedown event!”; | |
| } | |
| MAUImeter.prototype.click=function( ) | // mouse click |
| { | |
| } | |
| //// MAUImeter object initializer entry point | |
| // | |
| MAUIobjectNewInitialize(this,initializer); | // initialize object |
| if (initializer.xmlreq) | |
| { | |
| this.reflectXML(initializer); | // reflect XML into object |
| } | |
| var style=MAUIobjectStyle(this); | // setup style and layer id |
| var nid=“Layer”+initializer.index; | |
| this.paint(initializer.id, style, “”, initializer.index); | // paint meter |

| | |
|---|---|
| MAUIobjectLinkToParent(this, initializer.index); | // link to parent (success!) |
| safeloadXML(“temperature.xml”, this.update) | // update meter |
| } | |

| | |
|---|---|
| function MAUImeterRegisterClass( ) | // Register Meter Object Class |
| { | |

```
        MAUIregisterClass(“MAUImeter”,MAUImeterConstructor);
        }
```

| | |
|---|---|
| function MAUImeterConstructor( | // Meter Object Constructor |

| | |
|---|---|
| initializer) | // initializer reference |
| { | |

| | |
|---|---|
| var o=new MAUImeter(initializer); | // construct meter object with initializer |
| return o; | // return object reference |
| } | |
| ////////// | |

When the foregoing semantic objects are executed, they produce, in combination, an appliance 206 with a dial 202 and a meter 204, as shown in FIG. 2.

Observe that each component object includes a main entry point, an initializer entry point, a registration function, and a constructor function. Each function may also have one or more prototype message response functions (e.g., default overrides).

The invention may be implemented with various functions, such as a GET function, RETRIEVE VALUE, which is analogous to the World Wide Web Server GET operation, RETRIEVE PREVIOUS, which is analogous to GET, extended with a previous date range, RETRIEVE PROJECTION, which is analogous to GET, extended with a future date range and projection type, and RETRIEVE EVENT, which inserts a request into a queue, sleeps until awoken, de-queues, and performs a standard GET operation. A POST command may also be used. A RECORD command, analogous to a POST command, may be used to check an event retrieval queue and awake as necessary.

Those skilled in the art will recognize a number of noteworthy features associated with the invention. First, there is a deprecation of the functional programming/API methodology in favor of declarative object programming/component object library methodology. This decouples functionality from modality. The invention leverages this decoupling to provide diverse client hardware platform support. This decoupling provides enhanced reliability through pre-qualified program objects. This decoupling also provides enhanced security by significantly reducing potential vectors for any non-certified, executable programs to be inserted onto a client hardware platform without authentication.

The decoupling also provides a stand-alone as well as local and wide area network, distributed configurations. Thus, the invention provides intrinsic, symmetrical (and asymmetrical) parallel processing, dynamic loading, multi-computer, multi-processor and multi-core application architectural support. The invention may use an international Standard based functional programming language, such as JavaScript (ECMAScript) as an orthogonal means of implementing a rich component object library suitable for operation on any client hardware device that adheres to the International standard. The invention allows for the consistent use of simple Extensible Markup Language (XML) based semantic objects and program object descriptions to encode application modality as a collection of objects, object attributes and relationships to other objects.

The invention's programmatic closure dynamically instantiates an asynchronous program object within a local subset of the current scoping context in response to the retrieval of the associated program object declaration as specified by the associated program object declaration. The extension of standard World Wide Web server GET and POST functionality with a server side interlinked, event driven, blocking queue not only records and reports the value of semantic objects across a wide area network upon a server, but also relays events from objects of interest to the objects that hold them of interest in a resource efficient manner.

The invention reduces application program computer software enterprise costs across many axes, including initial development cost, recurring operating costs (including server/power/bandwidth expenses,) as well as the cost to adapt an application program to a different and new client hardware platform, while simultaneously increasing reliability, the ability of the enterprise operator to manage their growth and the ability of the user to manage performance. It is these attributes that make the design architecture worthy of consideration for a whole new class of stand-alone, inter-networked, collaborative hypermedia, process control, information, entertainment and other applications, along with a whole spectrum of new types of applications.

The performance of a computer software application can be objectively measured by a ratio representing the income generated by users of the application divided by the development cost plus the operating cost of creating and deploying the application. Success of an enterprise offering up a computer software application can be objectively measured by the margin between the income and these costs. The software design architecture presented here incorporates a novel approach to maximizing a potential user base (and thereby income), while minimizing both related development and operating costs, thereby enhancing both the measure of performance and potential success of enterprise. This approach is based on Multi Dimensional Scaling, or the ability of a computer software application, in this case, to scale along multiple axes: across different software and hardware platforms and configurations, across demographics and numbers of users, and ultimately, the number of possible transactions per user in a manageable fashion.

Many application development platforms claim to be the most suitable for a given set of reasons. Most often, they are the same reasons and they almost all take the same approach to addressing the commonly recognized, recurring issues that face computer software programmers.

The invention is most significantly differentiated from an API based approach by the deprecation of the Application Program Interface methodology in favor of the reentrant Component Object Library, instanced, configured and connected together using XML based Program Object Definitions. An application programmer no longer needs to worry about arcane API litanies, or subtle and difficult to find syntactic mistakes, and low level, functional, regression testing (or the lack thereof) and instead can focus on interpreting an application as a collection of semantic objects built from and linked together using simple XML based declarations.

The inherent asynchronous nature of the non-blocking, event driven, simultaneously operating, reentrant functional blocks residing at the foundation of the disclosed design architecture provides intrinsic support for symmetrical multiple processor (SMP) hardware configurations. SMP is an approach that is rapidly gaining acceptance as a means of addressing basic linear processing speed limitations (faster=more expensive) by performing multiple operations simultaneously, in parallel, using multiple (inexpensive=not as fast) computer cores operating in tandem.

Typical software applications have to be redesigned and rewritten (expensive) to be “threaded,” a technique necessary to take advantage of multiple simultaneous processors.

Software applications constructed using the disclosed architecture inherently take advantage of multiple computers connected via wide and local area networks, and multiple processors per computer and multiple cores per processor, without imposing any additional operating costs on the enterprise operator. This allows the user to select an appropriate client hardware platform based on their individual application cost/performance basis.

The design architecture described in this paper is optimized first for compatibility across a wide spectrum of client hardware platforms, and second for efficiency upon a particular client hardware platform Component Object Libraries implemented in a non-proprietary international standards based language such as JavaScript (ECMAScript) will function upon any client hardware platform that provides an international standard compliant World Wide Web browser. This includes all personal computers and workstations, as well as video games, embedded applications and appliances, consumer electronics, personal digital assistants, cell phones, media players, handhelds and other devices.

Each reentrant object within a Component Object Library represents a functional contract in as much as it embodies an implementation, in JavaScript or otherwise. And as such, its implementation is not limited to a JavaScript representation. A Component Object Library may be constructed from a specific type of a machine language (assembly language,) or may even be constructed using a programmable logic or other device, as long as the specific client implementation, in whatever form it might take, implements the functional contract as specified by standardized JavaScript implementation for any given object. It is in this fashion that massively multiple, simultaneous, users of an application, using a wide range of potential client hardware devices, inter-connected via a semantic object distributed event server, are able to reliably and interchangeably record and report events within a distributed network.

Each object is an encapsulated unit with well defined external interfaces. This allows objects to be constructed, tested and qualified independently and in parallel, even by different teams. Fully encapsulated software components with well defined interfaces suffer far less from unexpected side effects and co-dependencies.

One of the most costly aspects of World Wide Web based, application program, computer software development is the wide spectrum of non-orthogonal elements that must be both constructed and “glued” together. Each of the non-orthogonal elements typically requires a different language and or syntax, and requires and customer layer of “glue” code to attach it to other elements. For example, an application implemented in Java with a Flash user interface requires a programmer to learn and master both Java and Flash, and HTML and DOM and CSS and JavaScript to try and glue it all together. That is a very expensive, very busy and very beleaguered programmer.

The design architecture of the invention replaces this litany with a simple orthogonal system of XML based Semantic Objects and Program Object Descriptions (semantic objects in and of their own right.) A Pre-constructed, pre-tested and most importantly pre-qualified component object library renders all HTML, DOM. CSS, JavaScript automatically and as necessary to provide the benefit promised by the current trend in “Rich Internet Applications” without the related cost of a “cobbled together, non-orthogonal, every application is a brand new program from scratch,” development strategy.

The operating cost of a computer software application may be best described as the sum of the purchase cost to the client, running cost of the client, the running cost of the server and the cost of the bandwidth connecting the client and the server. The total cost of a computer software application to a user includes the cost of the hardware and recurring bandwidth charges required of the application, as well as the retail cost (if any) of the application itself.

The total cost of a computer software application to the enterprise includes the cost of server hardware and recurring energy and bandwidth charges required of the application, as well as the development cost of the application itself.

The quality of service represents both the ability to successfully complete user transactions, and the amount of time required to successfully complete each, individual, user transaction and is best described by a function reflecting the capabilities of the client platform (provided by the user), the capabilities of the server platform (provided by the operator) and the capabilities of the network connecting the two.

Variability of service describes the consistency of service best represented by the sum of the consistency of service provided by the client, the network and the server. Both the user and the enterprise operator have complete control over the quality of service of their respective client platform and server hardware, however, only the enterprise operator has control over the quality of service provided by the server hardware. It is the ability or difficulty to maintain (improve even) the quality of service during growth that ultimately determines the ability to continue to increase growth.

Scalability issues involving operating costs result directly from the many-to-one relationship between a growing user base and an enterprise operator. Operating cost increases for an operator on a per user basis. Many strategies have been devised to lower recurring, operator bandwidth and server costs. The disclosed design architecture seeks to absolutely minimize these costs where possible and distribute load as necessary.

Typical strategies currently used to improve enterprise operator server efficiencies involve the optimization of server-side computer software programs and the means by which server-side computer software programs are instantiated. The disclosed design architecture utilizes an entirely different strategy by completely removing the burden of dynamic content generation from the server operator and shifting it to the user's client hardware platform.

If X represents the cost incurred by the server to dynamically generate content, Y represents the cost incurred to transfer the dynamically generated content to the user, and Z represents the cost incurred by the user, the total recurring operator cost of delivering dynamically generated content becomes:

X*(Server Cost Per Server Hour)+Y*(Bandwidth Cost Per Byte/Hour)

The disclosed design architecture performs no dynamic content generation on the server. Instead, unprocessed, stored information and source inputs are transferred between the client and server, along with an appropriate XML based, program object declaration, so the appropriate program object running on the client hardware performs the necessary processing to dynamically generate content, locally. In this case X′=0, Y′<Y (typically) as long as the source data and inputs are smaller than the dynamically generated representation, and Z is significantly increased. In fact, this architecture potentially reduces one of the two main enterprise operation costs (bandwidth) significantly, and eliminates the other and previously most significant cost (the cost of generating dynamic content) entirely.

This approach considerably reduces the requirements (and thereby overall cost) placed on enterprise operators in order to maintain a consistency of service, while empowering a user with the ability to select a client hardware platform that most suitably addresses their measure of price/performance/quality of service on an individual basis.

An embodiment of the present invention relates to a computer storage product with a computer-readable medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using Java. C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A data processing method, comprising:
declaring a server semantic object that specifies an operation independent of implementation;
delivering the server semantic object to a plurality of clients in different hardware environments, wherein each hardware environment stores a client semantic object specifying processing operations that implement the operation associated with the server semantic object for the hardware environment;
combining the server semantic object with each client semantic object in each hardware environment to produce server semantic object data at each client; and
presenting the server semantic object data at each client in accordance with a common protocol observed by each client.

2. The data processing method of claim 1 wherein declaring includes declaring a standards based server semantic object.

3. The data processing method of claim 2 wherein declaring includes declaring an Extensible Markup Language (XML) server semantic object.

4. The data processing method of claim 1 wherein delivering includes delivering in accordance with a protocol.

5. The data processing method of claim 4 wherein delivering includes delivering in accordance with an international standards compliant protocol.

6. The data processing method of claim 5 wherein delivering includes delivering in accordance with Hyper Text Transaction Protocol (HTTP).

7. The data processing method of claim 4 wherein delivering includes delivering in accordance with a proprietary protocol.

8. The data processing method of claim 1 wherein presenting includes presenting the server semantic object data in accordance with a standards compliant protocol.

9. The data processing method of claim 1 wherein presenting includes presenting the server semantic object data in accordance with a World Wide Web Document Object Model.

10. A computer readable storage medium, comprising executable instructions to:
specify at least one server semantic object defining server semantic object attributes and relationships, wherein the server semantic object attributes and relationships are declared without specifying processing operations that implement the server semantic object attributes and relationships; and
respond to a client request to deliver server semantic object information.

11. The computer readable storage medium of claim 10 further comprising executable instructions to specify server semantic object attributes and relationships at a given point in time.

12. The computer readable storage medium of claim 11 further comprising executable instructions to respond to a client request to deliver server semantic object state information.

13. The computer readable storage medium of claim 12 further comprising executable instructions to deliver server semantic object state information in the form of a current server semantic object value.

14. The computer readable storage medium of claim 12 further comprising executable instructions to deliver server semantic object state information in the form of a previous server semantic object value.

15. The computer readable storage medium of claim 12 further comprising executable instructions to deliver server semantic object state information in the form of a change of state value.

16. The computer readable storage medium of claim 12 further comprising executable instructions to deliver server semantic object state information in the form of a derived value.

17. The computer readable storage medium of claim 10 wherein the executable instructions are stored on at least one of a networked computer, a non-networked computer, a handheld computer and an embedded device.

18. The computer readable storage medium of claim 10 wherein the executable instructions to specify include executable instructions to specify the at least one server semantic object as a standards compliant object.

19. The computer readable storage medium of claim 18 wherein the standards compliant object is defined in Extensible Markup Language (XML).

20. The computer readable storage medium of claim 10 wherein the executable instructions to specify include executable instructions to specify server semantic objects in JavaScript.

21. The computer readable storage medium of claim 18 wherein the standards compliant object is delivered using Hypertext Transaction Protocol (HTTP).

22. The computer readable storage medium of claim 18 wherein the standards compliant object is defined in assembly language.

23. The computer readable storage medium of claim 18 wherein the standards compliant object is defined in a high level programming language that requires interpretation.

24. The computer readable storage medium of claim 10 wherein the executable instructions to specify include executable instructions to specify at least one server semantic object in accordance with a proprietary standard.

25. The computer readable storage medium of claim 10 further comprising executable instructions to deliver the server semantic object information in accordance with a protocol.

26. The computer readable storage medium of claim 25 wherein the protocol is an international standards compliant protocol.

27. The computer readable storage medium of claim 25 wherein the protocol is Hyper Text Transport Protocol (HTTP).

28. The computer readable storage medium of claim 25 wherein the protocol is proprietary.

29. A computer readable storage medium, comprising executable instructions to:
retrieve at least one server semantic object defining server semantic object attributes and relationships, wherein the server semantic object attributes and relationships are declared without specifying processing operations that implement the server semantic object attributes and relationships; and
combine a server semantic object with a corresponding client semantic object that specifies processing operations that implement the server semantic object attributes and relationships to produce data.

30. The computer readable storage medium of claim 29 further comprising executable instructions to present the data.

31. The computer readable storage medium of claim 30 further comprising executable instructions to present the data in accordance with a standards compliant protocol.

32. The computer readable storage medium of claim 31 further comprising executable instructions to present the data as a World Wide Web Document Object Model.

33. The computer readable storage medium of claim 29 implemented as one of: discrete logic, a field programmable logic device, microcode silicon or flash memory.
